(19) United States
(12) Patent Application Publication
(10) Pub. No.: US 2013/0339938 A1
(43) Pub. Date: Dec. 19, 2013

(54) SYSTEM AND METHOD FOR UPDATING FIRMWARE

(71) Applicants: HONG FU JIN PRECISION INDUSTRY (ShenZhen) CO., LTD., (US); HON HAI PRECISION INDUSTRY CO., LTD., (US)

(72) Inventor: JIA HE, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/869,289

(22) Filed: Apr. 24, 2013

(30) Foreign Application Priority Data
Jun. 15, 2012 (CN) 2012101988743

(51) Int. Cl. G06F 9/445

(52) U.S. Cl. CPC G06F 8/65
USPC 717/168

(57) ABSTRACT

A method for updating firmware of a management engine (ME) of a Platform Controller Hub (PCH) chipset of an electronic device, firmware of the ME embedded in a storage device, the electronic device controls a voltage level of a protection pin to be low by setting a voltage level of a GPIO pin to be a low voltage level; generating a first control command to restart the electronic device to allow the firmware of the ME to be updated; and updating the firmware of the ME by writing update data into the storage device when the electronic device is restarted.

### BACKGROUND

1. Technical Field

Embodiments of the present disclosure relates to data management technology, and more particularly, to a system and method for updating firmware data of a management engine (ME) of a Platform Controller Hub (PCH) chipset of an electronic device.

2. Description of Related Art

Management engine (ME) of a Platform Controller Hub (PCH) chipset of an electronic device, acts as a controller to control peripheral function of the electronic device, and achieves advanced features such as power supply management of the electronic device. Because the ME plays an important role in the electronic device, to prevent accidental erasure or over-writing of firmware of the ME, a protection pin of the PCH chipset may be configured to protect the firmware of the ME.

When the electronic device begins Power-On Self-Test (POST), the protection pin allows the firmware of the ME to be updated when the voltage level of the protection pin is low, or prohibits the firmware of the ME being updated when the voltage level of the protection pin is high. Under this protection mechanism, a user who wants to update the firmware of the ME, usually changes the voltage level of the protection pin to be low. However, this change must be done manually and locally. This is inefficient. Therefore there is room for improvement in the art.

### BRIEF DESCRIPTION OF THE DRAWINGS

FIG. 1 is a block diagram of one embodiment of an electronic device comprising an updating system.

FIG. 2 is a block diagram of one embodiment of the updating system included in the electronic device of FIG. 1.

FIG. 3 is a flowchart of one embodiment of a firmware updating method.

FIG. 4 is a block diagram of another embodiment of the electronic device comprising the updating system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

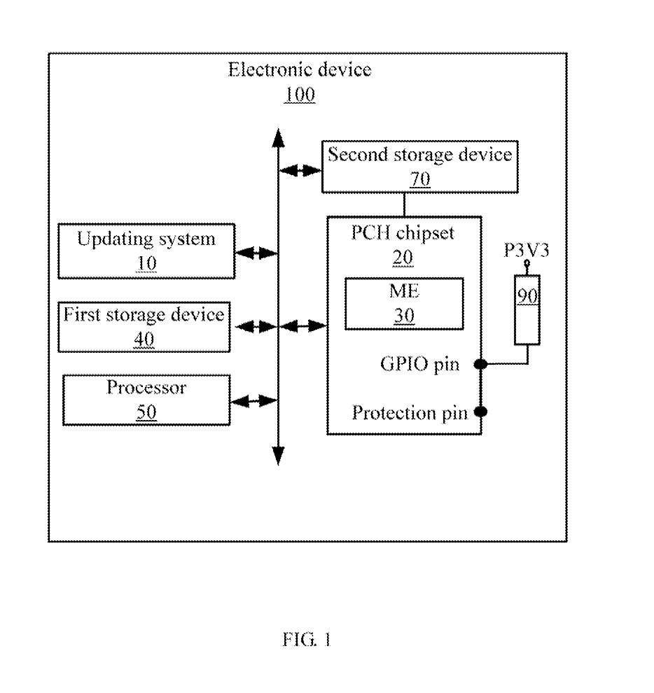

FIG. 1 is a block diagram of one embodiment of an electronic device 100 including an updating system 10. In other embodiments, the updating system 10 may be included in another electronic device, which may be connected to the electronic device 100 through a network. The electronic device 100 further includes a Platform Controller Hub (PCH) chipset 20, a first storage device 40, at least one processor 50, a second storage device 70, and a pull-up resistor 90.

The PCH chipset 20 includes a management engine (ME) 30, the ME 30 is used to control peripheral function of electronic device 100. For example, the ME 30 is used to achieve power supply management of the electronic device 100. In this embodiment, the updating system 10 is used to update a firmware of the ME 30.

In this embodiment, the first storage device 40 is a hard disk, the updating system 10 pre-stores firmware update data of the ME 30 in the first storage device 40. The second storage device 70 is a flash memory, the firmware of the ME 30 embedded in the second storage device 70, the second storage device 70 may further stores computerized codes of Basic Input/Output System (BIOS) of the electronic device 100.

A protection pin of the PCH chipset 20 may be configured to protect the firmware of the ME 30. When the electronic device 100 begins Power-On Self-Test (POST), the protection pin allows the firmware of the ME 30 to be updated when the voltage level of the protection pin is low, or prohibits the firmware of the ME 30 from being updated when the voltage level of the protection pin is high.

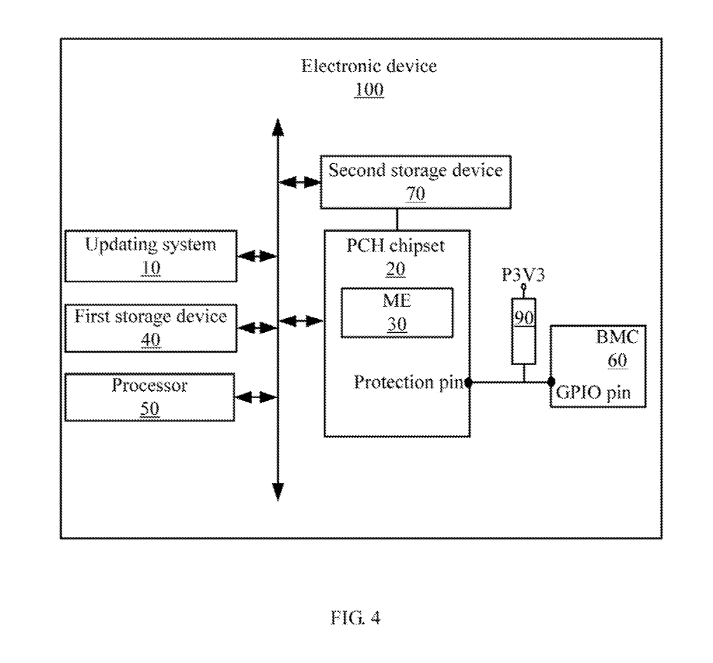

In this embodiment, the protection pin is connected to a General Purpose Input/Output (GPIO) pin. The GPIO pin may be a pin of the PCH chipset 20 (as shown in the FIG. 1) or a pin of a Baseboard Management Controller (BMC) 60 of the electronic device 100 (as shown in the FIG. 4). The GPIO pin is connected to one terminal of a pull-up resistor 90, the other terminal of the resistor 90 is connected to a power supply P3V3.

Because the protection pin is connected to the GPIO pin, the voltage level of the protection pin is the same as the GPIO pin. When the electronic device 100 is powered on and begins POST, the pull-up resistor 90 obtains the voltage (e.g., 3.3 volts), and pulls the voltage level of the GPIO pin to be high, then the voltage level of the protection pin is high. That is, when the electronic device 100 is powered on and begins POST for the first time, the voltage level of the protection pin is high, the protection pin prohibits the firmware of the ME 30 from being updated.

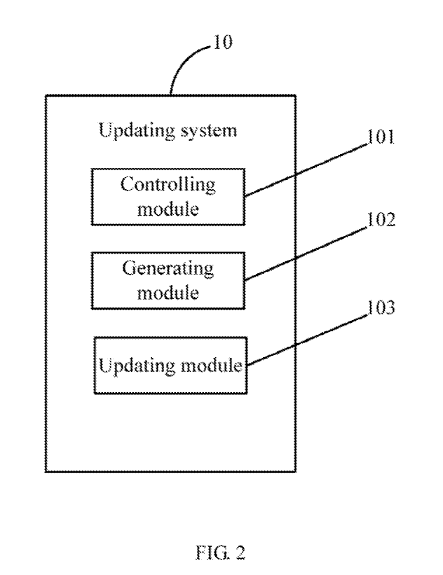

As shown in FIG. 2, the updating system 10 includes a controlling module 101, a generating module 102, and an updating module 103. The modules 101-103 may comprise computerized code in the form of one or more programs that are stored in the first storage device 40. The computerized code includes instructions that are executed by the at least one processor 50.

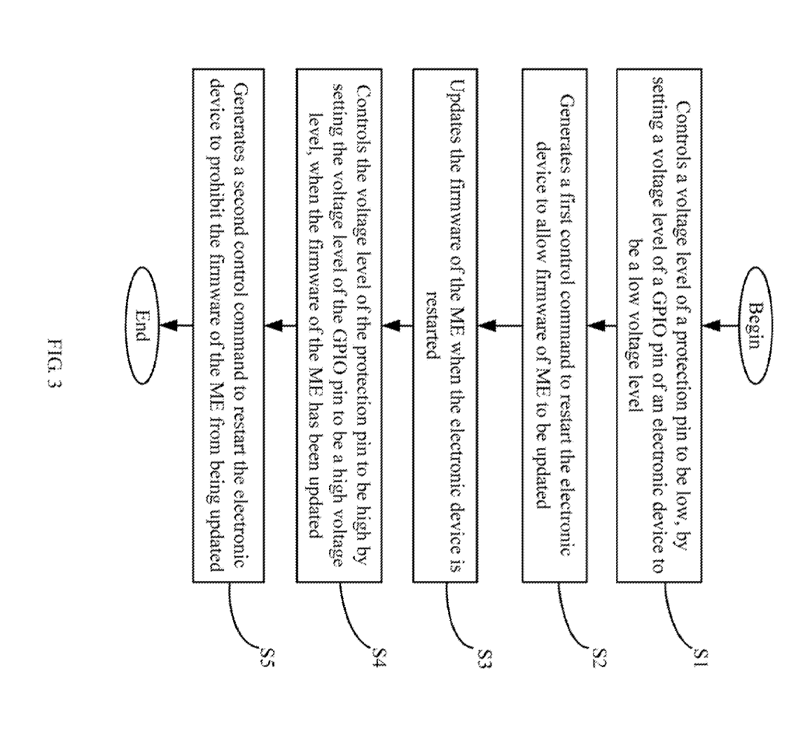

FIG. 3 is a flowchart of one embodiment of a firmware updating method. Depending on the embodiment, additional steps may be added, others removed, and the ordering of the steps may be changed.

In step S31, the controlling module 101 controls a voltage level of the protection pin to be low by setting a voltage level of the GPIO pin to be a low voltage level. As mentioned above, because the protection pin is connected to the GPIO pin, the voltage level of the protection pin is the same as the GPIO pin, that is, when the voltage level of the GPIO pin is set to be low, the voltage level of the protection pin changed to low correspondingly.

In step S2, the generating module 102 generates a first control command to restart the electronic device 100 to allow the firmware of the ME 30 to be updated. When the electronic device 100 restarts, the electronic device 100 performs POST again, then the protection pin allows the firmware of the ME 30 to be updated because the voltage level of the protection pin changed to low in step 51.

In step S3, the updating module 103 updates firmware of the ME 30. In one embodiment, the updating module 103 copies the update data that is pre-stored in the first storage device 40 and writes the update data to the second storage device 70 to complete the firmware updating operation. When the firmware of the ME 30 has been updated, the process goes to step S4.

In step S4, the controlling module 101 controls the voltage level of the protection pin to high by setting the voltage level of the GPIO pin to a high voltage level.

In step S5, the generating module 102 generates a second control command to restart the electronic device 100 to prohibit the firmware of the ME 30 from being updated.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for updating firmware of a management engine (ME) of a Platform Controller Hub (PCH) chipset of an electronic device, the electronic device comprises a first storage device, and at least one processor, the firmware of the ME embedded in a second storage device connecting to the PCH chipset, a protection pin of the PCH chipset connected to a General Purpose Input/Output (GPIO) pin of the electronic device, the method comprising:
controlling a voltage level of the protection pin to be low by setting a voltage level of the GPIO pin to be a low voltage level;
generating a first control command to restart the electronic device to allow the firmware of the ME to be updated; and
updating the firmware of the ME by writing update data into the second storage device when the electronic device is restarted.

2. The method of claim 1, further comprising:
controlling the voltage level of the protection pin to be high by setting the voltage level of the GPIO pin to be a high voltage level, when the firmware of the ME has been updated;
generating a second control command to restart the electronic device to prohibit the firmware of the ME from being updated.

3. The method of claim 1, wherein when the electronic device begins Power-On Self-Test (POST), the protection pin allows the firmware of the ME to be updated when the voltage level of the protection pin is low, or prohibits the firmware of the ME from being updated when the voltage level of the protection pin is high.

4. The method of claim 1, wherein the GPIO pin is a pin of the PCH chipset, the GPIO pin is connected to one terminal of a pull-up resistor, the other terminal of the pull-up resistor is connected to a power supply.

5. The method of claim 1, wherein the GPIO pin is a pin of a baseboard management controller (BMC) of the electronic device, the GPIO pin is connected to one terminal of a pull-up resistor, the other terminal of the pull-up resistor is connected to a power supply.

6. An electronic device, comprising:
a first storage device;
at least one processor;
a Platform Controller Hub (PCH) chipset comprising a management engine (ME);
a second storage device connected to the PCH chipset, being embedded with firmware used by the ME;
a General Purpose Input/Output (GPIO) pin connected to a protection pin of the PCH chipset; and
one or more programs that are stored in the first storage device and being executed by the at least one processor, the one or more programs comprising:
a controlling module that controls a voltage level of the protection pin to be low by setting a voltage level of the GPIO pin to be a low voltage level;
a generating module that generates a first control command to restart the electronic device to allow the firmware of the ME to be updated; and
an updating module that updates the firmware of the ME by writing update data into the second storage device when the electronic device is restarted.

7. The electronic device of claim 6, wherein the controlling module further controls the voltage level of the protection pin to be high by setting the voltage level of the GPIO pin to a high voltage level, when the firmware of the ME has been updated; and the generating module further generates a second control command to restart the electronic device to prohibit the firmware of the ME from being updated.

8. The electronic device of claim 6, wherein when the electronic device begins Power-On Self-Test (POST), the protection pin allows the firmware of the ME to be updated when the voltage level of the protection pin is low, or prohibits the firmware of the ME from being updated when the voltage level of the protection pin is high.

9. The electronic device of claim 6, wherein the GPIO pin is a pin of the PCH chipset, the GPIO pin is connected to one terminal of a pull-up resistor, the other terminal of the pull-up resistor is connected to a power supply.

10. The electronic device of claim 6, wherein the GPIO pin is a pin of a baseboard management controller (BMC) of the electronic device, the GPIO pin is connected to one terminal of a pull-up resistor, the other terminal of the pull-up resistor is connected to a power supply.

11. A non-transitory storage medium having stored thereon instructions that, when executed by a processor of an electronic device, causes the electronic device to perform a method for updating firmware of a management engine (ME) of a Platform Controller Hub (PCH) chipset of the electronic device, the electronic device further comprising a first storage device, and at least one processor, the firmware of the ME embedded in a second storage device that connected to the PCH chipset, and a protection pin of the PCH chipset connected to a General Purpose Input/Output (GPIO) pin of the electronic device, the method comprising:
controlling a voltage level of the protection pin to be low by setting a voltage level of the GPIO pin to be a low voltage level;
generating a first control command to restart the electronic device to allow the firmware of the ME to be updated; and
updating the firmware of the ME by writing update data into the second storage device when the electronic device is restarted.

12. The non-transitory storage medium of claim 11, wherein the method further comprising:
controlling the voltage level of the protection pin to be high by setting the voltage level of the GPIO pin to be a high voltage level, when the firmware of the ME has been updated;
generating a second control command to restart the electronic device to prohibit the firmware of the ME from being updated.

13. The non-transitory storage medium of claim 11, wherein when the electronic device begins to Power-On Self-Test (POST), the protection pin allows the firmware of the ME to be updated when the voltage level of the protection pin is low, or prohibits the firmware of the ME from being updated when the voltage level of the protection pin is high.

14. The non-transitory storage medium of claim 11, wherein the GPIO pin is a pin of the PCH chipset, the GPIO pin is connected to one terminal of a pull-up resistor, the other terminal of the pull-up resistor is connected to a power supply.

15. The non-transitory storage medium of claim 11, wherein the GPIO pin is a pin of a baseboard management controller (BMC) of the electronic device, the GPIO pin is connected to one terminal of a pull-up resistor, the other terminal of the pull-up resistor is connected to a power supply.
